(19) United States
(12) Patent Application Publication
(10) Pub. No.: US 2025/0016805 A1
(43) Pub. Date: Jan. 9, 2025

(54) CONGESTION CONTROL FOR MULTI-CARRIER V2X COMMUNICATION

(71) Applicant: QUALCOMM Incorporated, San Diego, CA (US)

(72) Inventors: Shuanshuan WU, San Diego, CA (US); Hui GUO, Beijing (CN); Anantharaman BALASUBRAMANIAN, San Diego, CA (US); Kapil GULATI, Belle Mead, NJ (US)

(21) Appl. No.: 18/709,786

(22) PCT Filed: Jan. 29, 2022
(86) PCT No.: PCT/CN2022/074921

§ 371 Date: May 13, 2024

(51) Int. Cl. H04W 72/40; H04W 72/566

(52) U.S. Cl. CPC H04W 72/40; H04W 72/569

(57) ABSTRACT

The apparatus may be a UE configured to measure a CBR for a set of resources for SL transmissions, the set of resources for SL transmissions comprising resources in a plurality of carriers. The apparatus may further be configured to evaluate a CR for the set of resources for SL transmissions, the CR being associated with at least one planned SL transmission in the set of resources for SL transmissions. The apparatus may also be configured to adjust, based on the measured CBR and the evaluated CR, the at least one planned SL transmission in the set of resources for SL transmissions.

### TECHNICAL FIELD

The present disclosure relates generally to communication systems, and more particularly, to sidelink (SL) communication.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be configured to measure a channel busy ratio (CBR) for a set of resources for SL transmissions, the set of resources for SL transmissions including resources in a plurality of carriers. The apparatus may also be configured to evaluate a channel occupancy ratio (CR) for the set of resources for SL transmissions, the CR being associated with at least one planned SL transmission in the set of resources for SL transmissions. The apparatus may further be configured to adjust, based on the measured CBR and the evaluated CR, the at least one planned SL transmission in the set of resources for SL transmissions.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network, in accordance with various aspects of the present disclosure.

FIG. 2 illustrates example aspects of a sidelink slot structure, in accordance with various aspects of the present disclosure.

FIG. 3 is a diagram illustrating an example of a base station and user equipment (UE) in an access network, in accordance with various aspects of the present disclosure.

FIG. 4 illustrates an example of sidelink communication between devices, in accordance with various aspects of the present disclosure.

FIG. 5 illustrates CBR measurements that may be made by a UE utilizing multiple carriers for SL communication in accordance with various aspects of the present disclosure.

FIG. 6 illustrates a CR evaluation associated with a slot ‘n’ and an associated CR evaluation window in accordance with various aspects of the present disclosure.

FIG. 7 includes a first diagram illustrating a CBR calculation for a set of multiple carriers with different amounts of available resources and a second diagram illustrating a CR calculation for the set of multiple carriers in accordance with various aspects of the present disclosure.

FIG. 8 is a call flow diagram illustrating a UE implementing congestion control in accordance with various aspects of the present disclosure.

FIG. 9 is a flowchart of a method of wireless communication.

FIG. 10 is a flowchart of a method of wireless communication.

FIG. 11 is a diagram illustrating an example of a hardware implementation for an apparatus.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. For example, implementations and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range a spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). It is intended that innovations described herein may be practiced in a wide variety of devices, chip-level components, systems, distributed arrangements, aggregated or disaggregated components, end-user devices, etc. of varying sizes, shapes, and constitution.

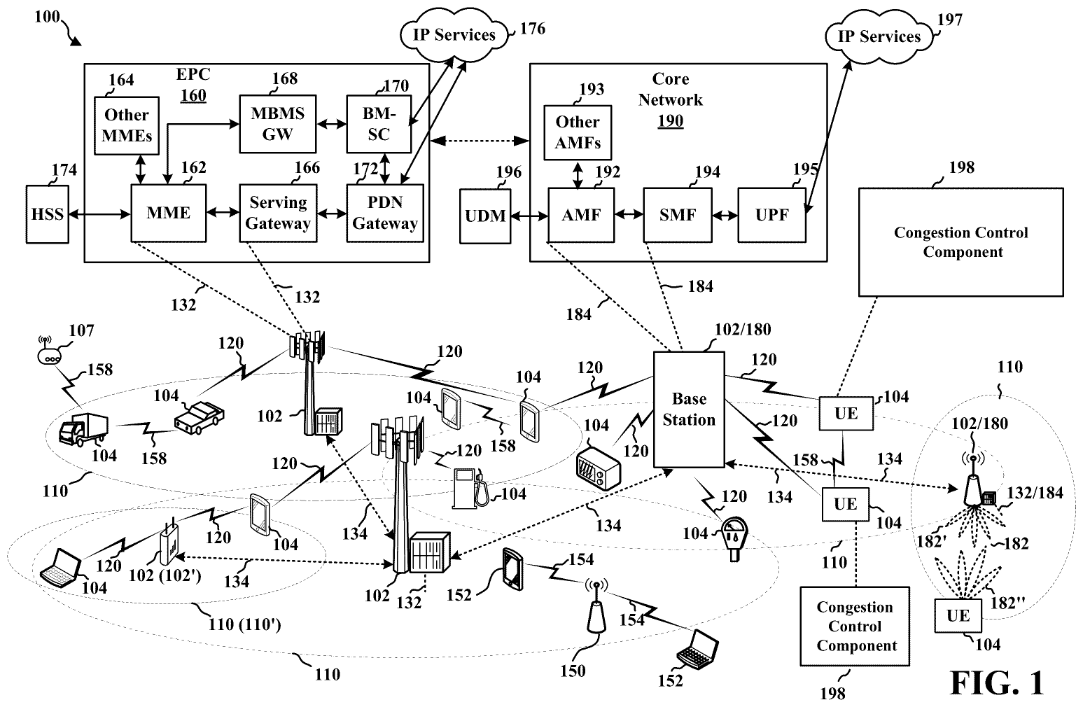

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G NR (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 GHz unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHz, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR2-2, and/or FR5, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHz spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a Packet Switch (PS) Streaming (PSS) Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may include a congestion control component 198 that may be configured to measure a CBR for a set of resources for SL transmissions, the set of resources for SL transmissions including resources in a plurality of carriers. The congestion control component 198 may also be configured to evaluate a CR for the set of resources for SL transmissions, the CR being associated with at least one planned SL transmission in the set of resources for SL transmissions. The congestion control component 198 may further be configured to adjust, based on the measured CBR and the evaluated CR, the at least one planned SL transmission in the set of resources for SL transmissions. Although the following description may be focused on 5G NR, the concepts described herein may be applicable to other similar areas, such as LTE, LTE-A, CDMA, GSM, and other wireless technologies.

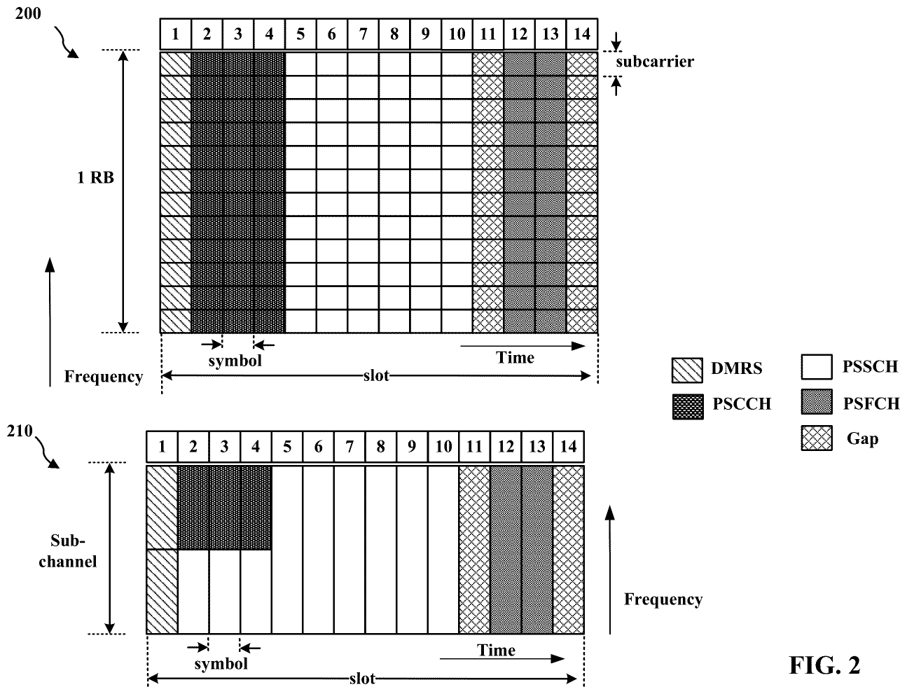

FIG. 2 includes diagrams 200 and 210 illustrating example aspects of slot structures that may be used for sidelink communication (e.g., between UEs 104, RSU 107, etc.). The slot structure may be within a 5G/NR frame structure in some examples. In other examples, the slot structure may be within an LTE frame structure. Although the following description may be focused on 5G NR, the concepts described herein may be applicable to other similar areas, such as LTE, LTE-A, CDMA, GSM, and other wireless technologies. The example slot structure in FIG. 2 is merely one example, and other sidelink communication may have a different frame structure and/or different channels for sidelink communication. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols may be CP orthogonal frequency division multiplexing (OFDM) (CP-OFDM) symbols. The symbols may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) and, effectively, the symbol length/duration, which is equal to 1/SCS.

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology p, there are 14 symbols/slot and 2^{μ} slots/subframe. The subcarrier spacing may be equal to 2*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIG. 2 provides an example of normal CP with 14 symbols per slot. Within a set of frames, there may be one or more different bandwidth parts (BWPs) that are frequency division multiplexed. Each BWP may have a particular numerology and CP (normal or extended).

Diagram 200 illustrates a single resource block of a single slot transmission, e.g., which may correspond to a 0.5 ms transmission time interval (TTI). A physical sidelink control channel may be configured to occupy multiple physical resource blocks (PRBs), e.g., 10, 12, 15, 20, or 25 PRBs. The PSCCH may be limited to a single sub-channel. A PSCCH duration may be configured to be 2 symbols or 3 symbols, for example. A sub-channel may comprise 10, 15, 20, 25, 50, 75, or 100 PRBs, for example. The resources for a sidelink transmission may be selected from a resource pool including one or more subchannels. As a non-limiting example, the resource pool may include between 1-27 subchannels. A PSCCH size may be established for a resource pool, e.g., as between 10-100% of one subchannel for a duration of 2 symbols or 3 symbols. The diagram 210 in FIG. 2 illustrates an example in which the PSCCH occupies about 50% of a subchannel, as one example to illustrate the concept of PSCCH occupying a portion of a subchannel. The physical sidelink shared channel (PSSCH) occupies at least one subchannel. The PSCCH may include a first portion of sidelink control information (SCI), and the PSSCH may include a second portion of SCI in some examples.

A resource grid may be used to represent the frame structure. Each time slot may include a resource block (RB) (also referred to as physical RBs (PRBs)) that extends 12 consecutive subcarriers. The resource grid is divided into multiple resource elements (REs). The number of bits carried by each RE depends on the modulation scheme. As illustrated in FIG. 2, some of the REs may include control information in PSCCH and some REs may include demodulation RS (DMRS). At least one symbol may be used for feedback. FIG. 2 illustrates examples with two symbols for a physical sidelink feedback channel (PSFCH) with adjacent gap symbols. A symbol prior to and/or after the feedback may be used for turnaround between reception of data and transmission of the feedback. The gap enables a device to switch from operating as a transmitting device to prepare to operate as a receiving device, e.g., in the following slot. Data may be transmitted in the remaining REs, as illustrated. The data may comprise the data message described herein. The position of any of the data, DMRS, SCI, feedback, gap symbols, and/or LBT symbols may be different than the example illustrated in FIG. 2. Multiple slots may be aggregated together in some aspects.

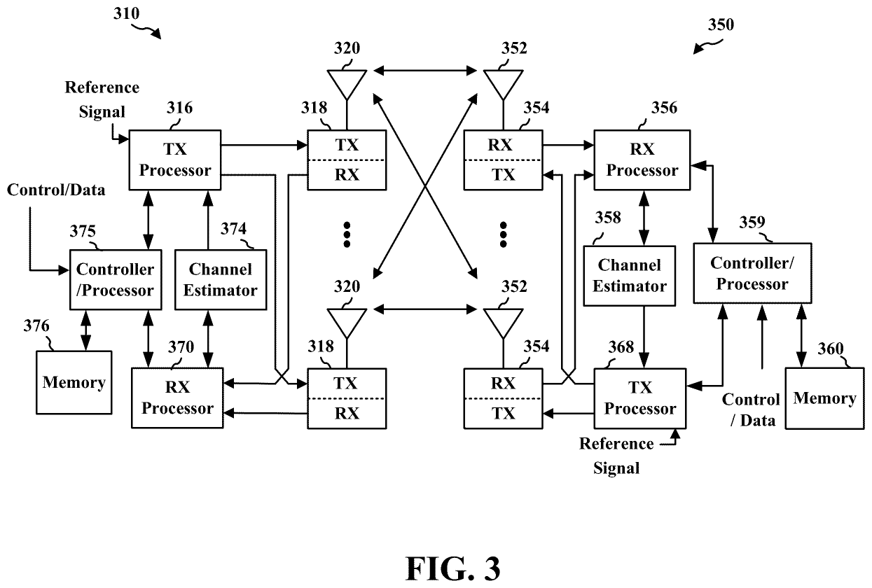

FIG. 3 is a block diagram of a base station 310 in communication with a UE 350 in an access network. In the DL, IP packets from the EPC 160 may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter at RX/TX 318. Each transmitter at RX/TX 318 may modulate a radio frequency (RF) carrier with a respective spatial stream for transmission.

At the UE 350, each receiver at RX/TX 354 receives a signal through its respective antenna 352. Each receiver at RX/TX 354 recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters at RX/TX 354. Each transmitter at RX/TX 354 may modulate an RF carrier with a respective spatial stream for transmission.

The UL transmission is processed at the base station 310 in a manner similar to that described in connection with the receiver function at the UE 350. Each receiver at RX/TX 318 receives a signal through its respective antenna 320. Each receiver at RX/TX 318 recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK and/or NACK protocol to support HARQ operations.

At least one of the TX processor 368, the RX processor 356, and the controller/processor 359 may be configured to perform aspects in connection with 198 of FIG. 1.

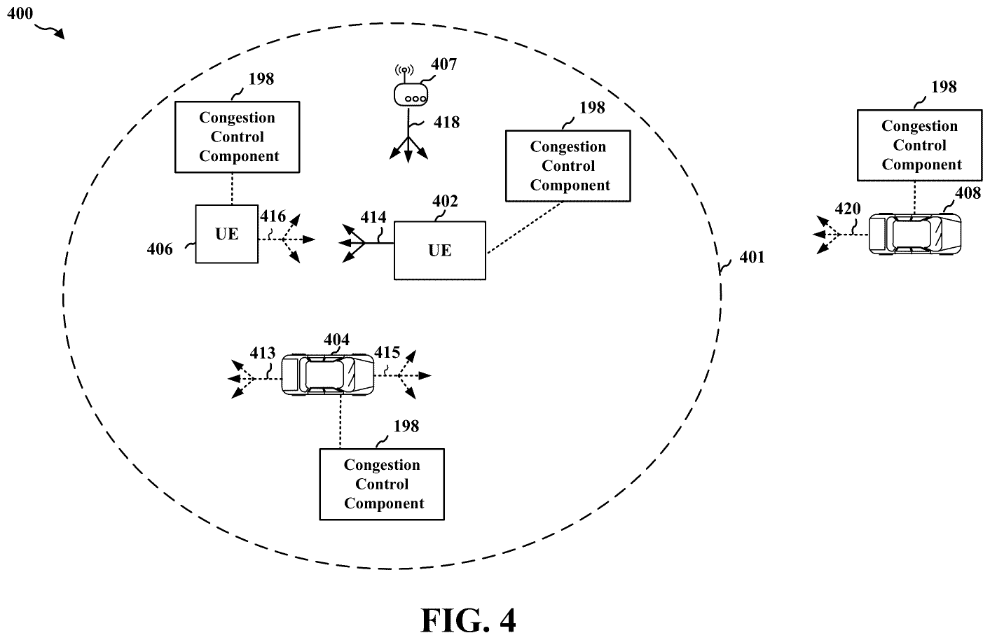

FIG. 4 illustrates an example 400 of sidelink communication between devices. The communication may be based on a slot structure including aspects described in connection with FIG. 2. For example, the UE 402 may transmit a sidelink transmission 414, e.g., including a control channel (e.g., PSCCH) and/or a corresponding data channel (e.g., PSSCH), that may be received by UEs 404, 406, 408. A control channel may include information (e.g., sidelink control information (SCI)) for decoding the data channel including reservation information, such as information about time and/or frequency resources that are reserved for the data channel transmission. For example, the SCI may indicate a number of TTIs, as well as the RBs that will be occupied by the data transmission. The SCI may also be used by receiving devices to avoid interference by refraining from transmitting on the reserved resources. The UEs 402, 404, 406, 408 may each be capable of sidelink transmission in addition to sidelink reception. Thus, UEs 404, 406, 408 are illustrated as transmitting sidelink transmissions 413, 415, 416, 420. The sidelink transmissions 413, 414, 415, 416, 420 may be unicast, broadcast or multicast to nearby devices. For example, UE 404 may transmit sidelink transmissions 413, 415 intended for receipt by other UEs within a range 401 of UE 404, and UE 406 may transmit sidelink transmission 416. In some aspects, RSU 407 may receive communication from and/or transmit communication 418 to UEs 402, 404, 406, 408. One or more of the UEs 402, 404, 406, 408 or the RSU 407 may include a congestion control component 198 as described in connection with FIG. 1.

Sidelink communication may be based on different types or modes of resource allocation mechanisms. In a first resource allocation mode (which may be referred to herein as “Mode 1”), centralized resource allocation may be provided by a network entity. For example, a base station 102 or 180 may determine resources for sidelink communication and may allocate resources to different UEs 104 to use for sidelink transmissions. In this first mode, a UE receives the allocation of sidelink resources from the base station 102 or 180. In a second resource allocation mode (which may be referred to herein as “Mode 2”), distributed resource allocation may be provided. In Mode 2, each UE may autonomously determine resources to use for sidelink transmission. In order to coordinate the selection of sidelink resources by individual UEs, each UE may use a sensing technique to monitor for resource reservations by other sidelink UEs and may select resources for sidelink transmissions from unreserved resources. Devices communicating based on sidelink, may determine one or more radio resources in the time and frequency domain that are used by other devices in order to select transmission resources that avoid collisions with other devices. The sidelink transmission and/or the resource reservation may be periodic or aperiodic, where a UE may reserve resources for transmission in a current slot and up to two future slots (discussed below).

Thus, in the second mode (e.g., Mode 2), individual UEs may autonomously select resources for sidelink transmission, e.g., without a central entity such as a base station indicating the resources for the device. A first UE may reserve the selected resources in order to inform other UEs about the resources that the first UE intends to use for sidelink transmission(s).

In some examples, the resource selection for sidelink communication may be based on a sensing-based mechanism. For instance, before selecting a resource for a data transmission, a UE may first determine whether resources have been reserved by other UEs.

For example, as part of a sensing mechanism for resource allocation Mode 2, the UE may determine (e.g., sense) whether the selected sidelink resource has been reserved by other UE(s) before selecting a sidelink resource for a data transmission. If the UE determines that the sidelink resource has not been reserved by other UEs, the UE may use the selected sidelink resource for transmitting the data, e.g., in a PSSCH transmission. The UE may estimate or determine which radio resources (e.g., sidelink resources) may be in-use and/or reserved by others by detecting and decoding sidelink control information (SCI) transmitted by other UEs. The UE may use a sensing-based resource selection algorithm to estimate or determine which radio resources are in-use and/or reserved by others. The UE may receive SCI from another UE that includes reservation information based on a resource reservation field included in the SCI. The UE may continuously monitor for (e.g., sense) and decode SCI from peer UEs. The SCI may include reservation information, e.g., indicating slots and RBs that a particular UE has selected for a future transmission. The UE may exclude resources that are used and/or reserved by other UEs from a set of candidate resources for sidelink transmission by the UE, and the UE may select/reserve resources for a sidelink transmission from the resources that are unused and therefore form the set of candidate resources. The UE may continuously perform sensing for SCI with resource reservations in order to maintain a set of candidate resources from which the UE may select one or more resources for a sidelink transmission. Once the UE selects a candidate resource, the UE may transmit SCI indicating its own reservation of the resource for a sidelink transmission. The number of resources (e.g., sub-channels per subframe) reserved by the UE may depend on the size of data to be transmitted by the UE. Although the example is described for a UE receiving reservations from another UE, the reservations may also be received from an RSU or other device communicating based on sidelink.

In addition to using the resource selection methods described above to avoid conflicts between transmissions from different UEs, some UEs may apply congestion control to reduce the likelihood of causing a conflict and/or to ensure that the UE does not consume too many resources. In some aspects, “too many resources” may be specified by a configured or known (e.g., preconfigured) CR threshold associated. A congestion control mechanism for a single carrier may address issues of congestion for a UE utilizing a single carrier, but may not adequately address congestion issues associated with a UE utilizing multiple carriers for SL communication. For example, for a UE utilizing multiple carriers, a transmission associated with a first carrier may be associated with a CR that is above a CR threshold, while the transmission could be sent on one of the other available carriers without causing a CR to be above a CR threshold or may be able to be transmitted if a CBR and CR are measured and evaluated, respectively, for the resources across the multiple carriers. The single-carrier congestion control may lead the UE to cancel the transmission, while the multi-carrier congestion control may enable the transmission in different ways as discussed below. Aspects presented herein provide for improved utilization of SL resources and channel access in a multi-carrier system.

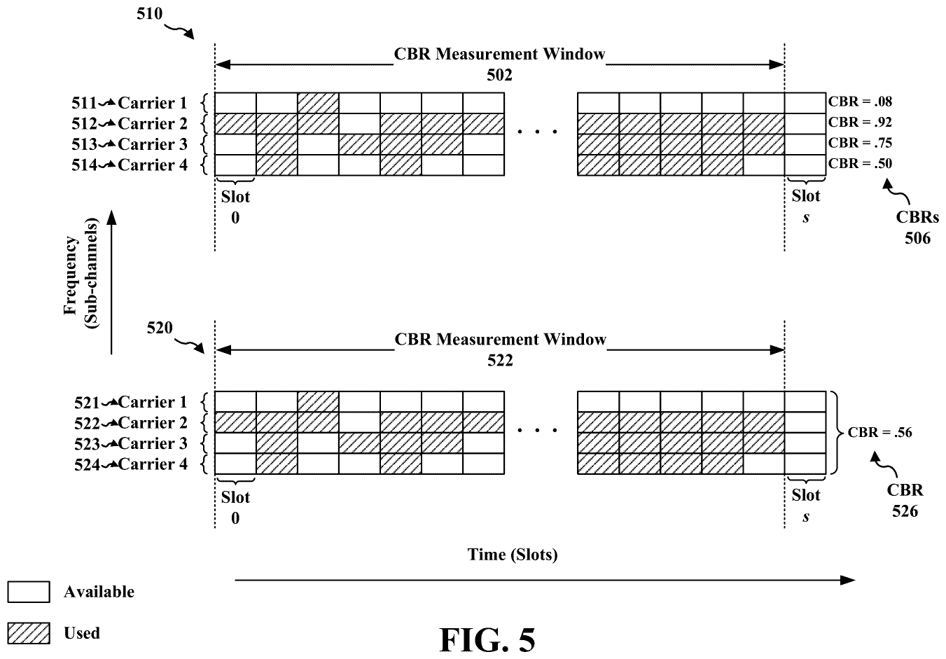

In implementing congestion control, a CR threshold may be specified or configured for each of a plurality of different carriers and, for each carrier, may depend on a measured CBR associated with the carrier and/or a priority associated with a particular planned transmission. FIG. 5 illustrates CBR measurements that may be made by a UE utilizing multiple carriers for SL communication in accordance with various aspects of the present disclosure. A CBR for a particular carrier associated with a slot ‘s’ may be defined (or calculated) as the fraction of resources (e.g., sub-channels, slots in each sub-channel, resource elements, etc.) in a resource pool for which a sidelink received signal strength indicator (SL RSSI) measured by the UE exceeds a configured or known (pre-configured) threshold. The CBR measurement window 502 may be defined as a set of slots including slots ‘s−a’ to ‘s−1’, where ‘a’ may be equal to 100 or 100-2 slots, according to a higher layer parameter sl-timeWindowSize-CBR. For example, the sl-timeWindowSize-CBR, in some aspects, may indicate a sensing window (e.g., the CBR measurement window 502) length of 100 milliseconds.

Diagram 510 illustrates a first, per-carrier, CBR measurement during a CBR measurement window 502 in accordance with various aspects of the present disclosure. For a set of four contiguous carriers 511, 512, 513, and 514 that are utilized for SL communication by a UE, the UE may calculate a CBR in the set of CBRs 506 separately for each carrier. The UE may subsequently calculate an average CBR for the set of carriers 511 to 514. In some aspects, the carriers used for SL communication by a UE may be non-contiguous and each carrier may be of a different width.

Diagram 520 illustrates a second, aggregate CBR measurement that is calculated based on the aggregated resources across the carriers used by the UE for SL communication. For a set of four contiguous carriers 521, 522, 523, and 524 that are utilized for SL communication by a UE, the UE may calculate a CBR 526 separately for the set of carriers as a whole. In some aspects, measuring the aggregate CBR may not provide information regarding the CBR of each carrier. In some aspects, the carriers used for SL communication by a UE may be non-contiguous and each carrier may be of a different width.

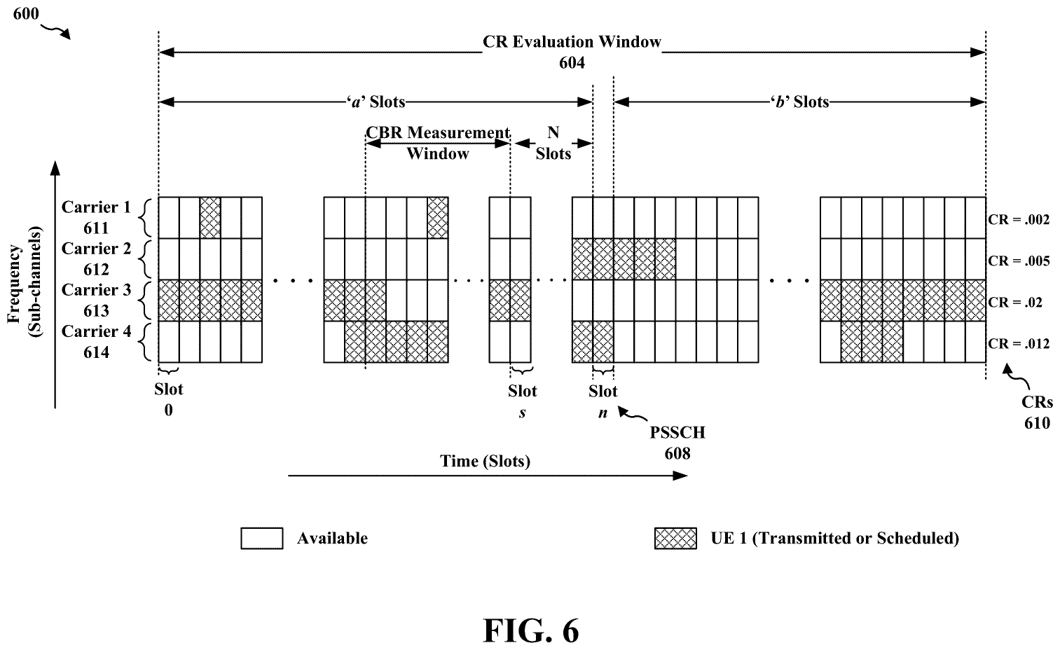

FIG. 6 illustrates a CR calculation associated with a slot ‘n’ and an associated CR evaluation window 604 in accordance with various aspects of the present disclosure. In some aspects, a CR for each carrier 611, 612, 613, and 614 may be evaluated, for a slot n, as the total number of resources (e.g., sub-channels) used for its transmissions in slots ‘n−a’ to ‘n−1’ and granted in slots ‘n’ to ‘n+b’ divided by the total number of configured resources (e.g., sub-channels) in the transmission pool over slots ‘n−a’ to ‘n+b’ where ‘a’ is a positive integer (different from the parameter ‘a’ used for the CBR measurement window) and ‘b’ is 0 or a positive integer. In some aspects, a and b are determined by UE implementation with a+b+1=1000 or 1000−2 slots based on a higher layer parameter sl-timeWindowSize-CR, where b<(a+b+1)/2, and n+b does not exceed the last transmission opportunity of the grant for the current transmission. In some aspects, the SL CR is evaluated based on planned transmissions and retransmissions. In evaluating the SL CR, the UE may assume a transmission parameter used at slot n is reused according to the existing grant(s) in slots ‘n+1’ to ‘n+b’ without packet dropping. The slot index, in some aspects, is based on a physical slot index. In some aspects, a SL CR may be computed per priority level. The CR may be associated with a PSSCH transmission 608 at slot n.

A CR threshold may be specified or configured for each of a plurality of different carriers and, for each carrier, may depend on a measured CBR associated with the carrier and/or a priority associated with the particular planned transmission. For example, a UE may be configured with one or more higher-layer parameters sl-CR-Limit that each indicate at least one CR threshold that indicates a maximum CR associated with planned SL transmissions via one or more carriers. A UE may be configured to ensure particular limits for any priority value k, e.g., Σ_{i≥k}CR(i)≤CRₗᵢₘᵢₜ(k), where CR(i) is the CR evaluated in slot n for the PSSCH transmissions (e.g., PSSCH transmission 608) with “Priority” field in the SCI set to i, and CR_{Limit}(k) corresponds to the high layer parameter sl-CR-Limit that is associated with the priority value k and the CBR range which includes the CBR measured in slot n−N (e.g., slot s of FIGS. 5 and 6), where N is the congestion control processing time. In some aspects, the congestion control processing time N is based on a numerology μ (subcarrier spacing of sidelink) and a UE processing capability.

For example, a configuration of CR limits for a measured CBR based on a pro-se per packet priority (PPPP) may be provided as:

| | PPPP1-PPPP2 | PPPP3-PPPP5 | PPPP6-PPPP8 |
|---|---|---|---|
| Measured CBR | CR Limit | CR Limit | CR Limit |
| 0 ≤ Measured CBR ≤ 0.3 | No Limit | No Limit | No Limit |
| 0.3 < Measured CBR ≤ 0.65 | No Limit | 0.03 | 0.02 |
| 0.65 < Measured CBR ≤ 0.8 | 0.02 | 0.006 | 0.004 |
| 0.8 < Measured CBR ≤ 1 | 0.02 | 0.003 | 0.002 |

The above example configuration indicates that as the channel becomes busier (e.g., is associated with a higher measured CBR), a UE may enforce more restrictive limits on the CR for each PPPP level. The above example configuration also indicates that as a priority (e.g., a PPPP) decreases, e.g., a PPPP index increases, the UE may enforce more restrictive CR limits. This example configuration, or other similar configuration, of CR limits for a measured CBR based on PPPP illustrates a congestion control functionality for enhancing a ‘fairness’ of SL resource usage by preventing a single UE from flooding a busy system (e.g., a system with a high measured CBR) with large numbers of transmissions.

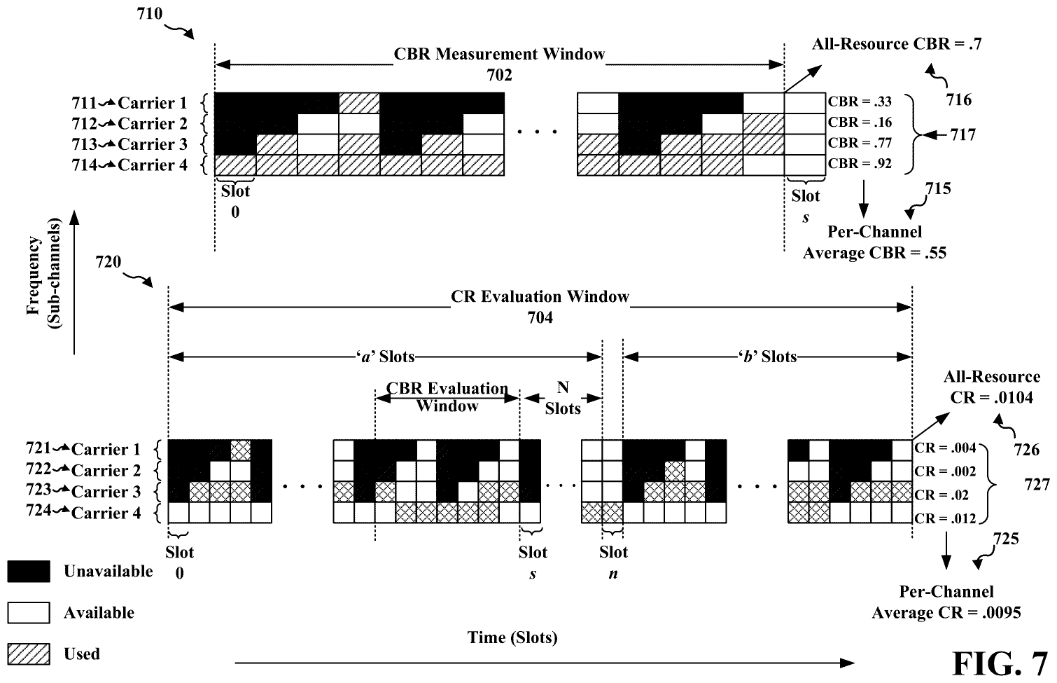

FIG. 7 includes a first diagram 710 illustrating a CBR calculation for a set of multiple carriers 711, 712, 713, and 714 with different amounts of available resources and a second diagram 720 illustrating a CR evaluation for the set of multiple carriers 721, 722, 723, and 724 in accordance with various aspects of the present disclosure. The CBR and/or CR may be calculated for each carrier separately during a CBR measurement window 702 and a CR evaluation window 704 respectively. After calculating the separate CBRs (e.g., CBRs 717) and/or CRs (e.g., CRs 727), a UE may calculate a per-carrier (or per-channel) average CBR 715 and/or CR 725 (e.g., a CBR of 0.55 and/or a CR of 0.0095 based on a sum of the CBR and/or CR calculated for each carrier divided by the number of carriers in FIG. 7). In some aspects, a UE may calculate an all-resource CBR 716 and/or CR 726 (e.g., a CBR of 0.7 and/or a CR of 0.0104 in FIG. 7 based on the aggregated resources across the set of multiple carriers). As illustrated in FIG. 7, when different carriers have different numbers or amounts of resources available, an average CBR 715 and/or CR 725 may differ from an all-resource CBR 716 and/or CR 726. This may be contrasted with the examples illustrated in FIGS. 5 and 6 in which each carrier was assumed to include a same number of resources and therefore the average of the separately measured and/or evaluated CBRs in the set of CBRs 506 and/or CRs 610 was the same as the calculated CBR 526 and/or CR for the aggregated resources.

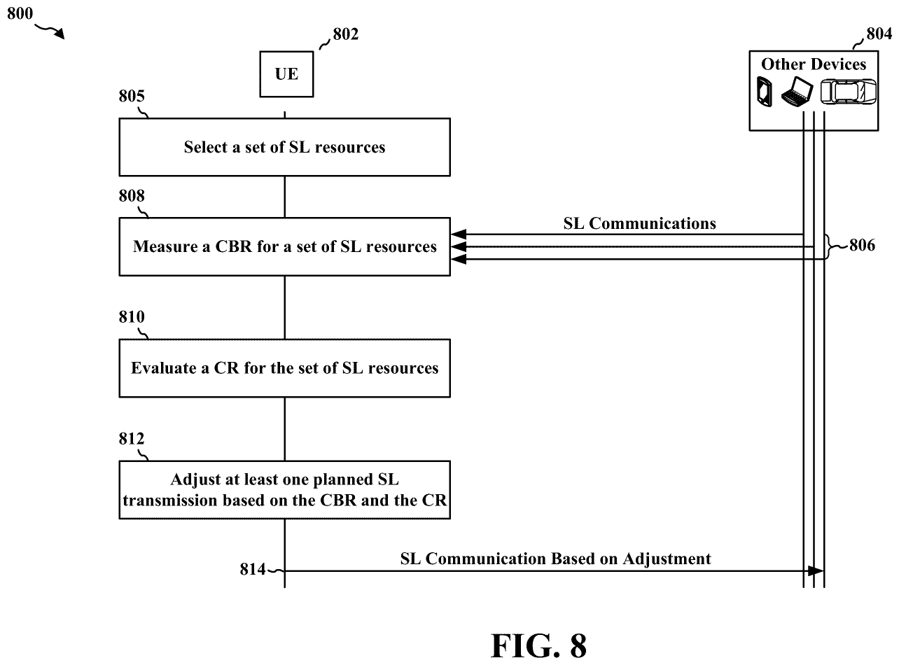

FIG. 8 is a call flow diagram 800 illustrating a UE 802 implementing congestion control in accordance with various aspects of the present disclosure. FIG. 8 illustrates that a UE 802 may select 805 a set of resources for SL transmissions. The UE 802 may select 805 the set of resources for SL transmissions based on one or more of a capacity of the UE, a capacity of a second UE with which the UE communicates, or a communication between the UE and the second UE. The selection 805, in some aspects, corresponds to an autonomous (e.g., Mode 2) SL resource selection process. The set of resources for SL transmissions, in some aspects, may include (1) a plurality of carriers or (2) a set of SL resource pools in the plurality of carriers.

The UE 802 may measure 808 a CBR for the set of SL resources. The set of SL resources (e.g., a set of carriers for SL transmissions or a set of SL resource pools in a set of carriers) may be determined by the UE 802. The determination may be based on one or more of how many carriers the UE 802 is able to use for transmissions, how many carriers an intended recipient of a SL transmission is able to use for receiving SL transmissions, or a negotiation between the UE 802 and one or more other devices 804 (e.g., UEs, vehicles, RSUs, etc.) with which the UE communicates via the determined set of SL resources. The set of SL resources, in some aspects, includes resources associated with multiple carriers.

For the determined set of SL resources, the UE may measure 808 the CBR based on SL communications 806 received from one or more other devices 804 via the set of SL resources. The CBR measurement may be performed for each carrier in the set of SL resources separately or for the set of SL resources as a whole as described above in relation to FIGS. 5 and 7. The UE 802 may further evaluate 810 a CR for the set of SL resources. The UE 802 may evaluate 810 the CR for the set of SL resources for each carrier separately or for the set of SL resources as a whole as discussed in relation to FIGS. 6 and 7.

Based on the CBR and the CR, the UE 802 may adjust 812 at least one planned SL transmission in a set of planned SL transmissions. For example, in some aspects, the UE may measure 808 the CBR and evaluate 810 the CR for each carrier in the set of SL resources separately as illustrated in diagrams 510, 600, 710, and 720 of FIGS. 5 to 7. The UE 802 may determine, based on a CR limit associated with the measured 808 CBR for the carrier, whether the evaluated 810 CR for the carrier is above the limit. As discussed above, for a particular measured 808 CBR, a CR limit may be specified (e.g., known or configured) for a plurality of priority (e.g., PPPP) ranges. This determination may be performed based on a (pre)configured CBR to CR limit mapping (there may be a CBR to CR limit mapping for each priority), and a priority of the transmission the UE intends to transmit. This determination may be performed for each carrier in the set of SL resources and each carrier may have a same, or a different, mapping of CBR to CR limits. The UE 802 may then adjust 812 at least one planned SL transmission in the set of planned SL transmissions by determining that the at least one planned SL transmission will not be transmitted (e.g., will be dropped). The at least one planned SL transmission may be associated with a first set of one or more carriers in the set of SL resources, with transmissions associated with other carriers in the set of SL resources not being adjusted based on the CR limit not being exceeded for SL transmissions associated with the other carriers in the set of SL resources. In some aspects The UE 802 may adjust 812 the at least one planned SL transmission by reducing a set of resources associated with the at least one planned SL transmission such that the CR is reduced below the CR limit.

Additionally, or alternatively, the UE 802 may adjust 812 at least one planned SL transmission in the set of planned SL transmissions by identifying, for the at least one SL transmission, a set of candidate carriers. The set of candidate carriers may be identified as the carriers for which the CR does not exceed a CR limit (e.g., a CR limit specified for the priority of the at least one SL transmission). After identifying the set of candidate carriers, the UE 802 may select a carrier from the set of candidate carriers for the at least one SL transmission. In some aspects, the at least one SL transmission may be a SL transmission associated, before the adjustment, with a first carrier with an evaluated 810 CR that exceeds a CR limit for the priority level of the at least one SL transmission. By identifying the set of candidate carriers, the at least one SL transmission may be transmitted on a different carrier instead of being dropped.

In some aspects, the UE may measure 808 the CBR and evaluate 810 the CR for the set of SL resources. The CBR and CR may be measured and evaluated, respectively, for each carrier in the set of SL resources separately as illustrated in diagrams 510 and 600 of FIGS. 5 and 6, and averaged to calculate an average CBR (e.g., per-channel average CBR 715) and CR (e.g., per-channel average CR 725) for the set of SL resources as illustrated in diagrams 710 and 720 of FIG. 7. Alternatively, or additionally, the CBR (e.g., CBR 526 or all-resource CBR 716) and CR (e.g., all-resource CR 726) may be measured and evaluated, respectively, for the set of SL resources as a whole as illustrated in diagrams 520, 710 and 720 of FIGS. 5 and 7. The measured CBR (e.g., the per-channel average CBR 715 or the all-resource CBR 716) for the set of SL resources may be used to determine a set of CR limits for SL transmissions with priorities falling in different ranges of priorities as discussed above.

The UE may determine, for the set of SL resources as a whole, whether any planned transmission is associated with a CR that is above the CR limit corresponding to the priority of the planned transmission. For each planned SL transmission for which the associated CR exceeds the corresponding CR limit, the UE 802 may adjust the planned SL transmission by determining that the planned SL transmission will not be transmitted (e.g., will be dropped). A higher-priority transmission that, if the CBR and CR were calculated separately for each carrier, would have been dropped may not be dropped based on the CBR and CR calculated for the set of SL resources as a whole. For example, if a particular carrier in the set of SL resources has a measured CBR that maps to a CR limit for SL transmissions with PPPP1 of 0.02 and the CR for the particular carrier is (or would be) above 0.02 a particular SL transmission via the particular carrier with PPPP1 would be dropped. But, when considering the set of SL resources as a whole, the particular SL transmission may not be dropped based on (1) the measured CBR for the set of SL resources as a whole mapping to a higher CR limit and/or (2) the CR evaluated for the set of SL resources as a whole being lower than the CR evaluated for the particular carrier by itself. Additionally, or alternatively, if the UE determines to drop any transmissions, it becomes more likely that lower-priority SL transmissions are dropped before dropping higher-priority SL transmissions. The UE 802 may then transmit a SL communication based on the adjustment 814.

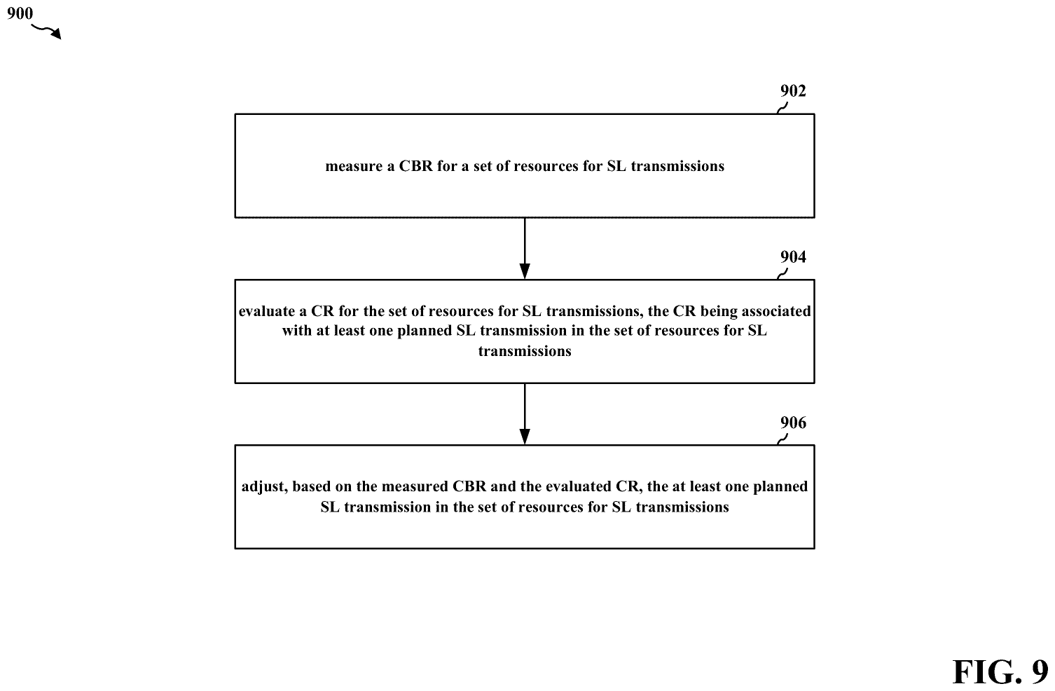

FIG. 9 is a flowchart 900 of a method of wireless communication. The method may be performed by a UE (e.g., the UE 104, 402-408, and 802; the apparatus 1102). At 902, the UE may measure a CBR for a set of resources for SL transmissions. For example, 902 may be performed by CBR measurement component 1142. In some aspects, the set of resources for SL transmissions may include resources in a plurality of carriers. For example, the set of resources for SL transmissions may include (1) the plurality of carriers or (2) a set of SL resource pools in the plurality of carriers. The set of resources for SL transmissions may have been selected by the UE based on one or more of a capacity of the UE, a capacity of a second UE with which the UE communicates, or a communication between the UE and the second UE. The selection, in some aspects, corresponds to an autonomous (e.g., Mode 2) SL resource selection process.

Measuring, at 902, the CBR may include measuring a CBR for each SL resource pool in the set of SL resource pools or measuring a CBR for each carrier in the plurality of carriers. In some aspects, measuring, at 902, the CBR may include one of (1) measuring a first CBR for the selected set of resources for SL transmissions as a whole or (2) measuring a second CBR for the selected set of resources for SL transmissions for each carrier (e.g., measuring a CBR for (i) each SL resource pool in the set of SL resource pools or (ii) each carrier in the plurality of carriers), and calculating an average CBR for the selected set of resources for SL transmissions (e.g., the set of SL resource pools or the plurality of carriers) based on the measured second CBRs. For example, referring to FIGS. 5, 7, and 8, the UE 802 may measure 808 a CBR for a set of SL resources (e.g., the set of CBRs 506, the CBR 526, or the CBRs 717) as described in relation to FIGS. 5 and 7.

At 904, the UE may evaluate a CR for the set of resources for SL transmissions. The CR evaluated at 904 may be associated with at least one planned SL transmission in the set of resources for SL transmissions. For example, 904 may be performed by a CR evaluation component 1144. In some aspects, evaluating the CR at 904 may include evaluating a CR for each SL resource pool in the set of SL resource pools or for each carrier in the plurality of carriers. Evaluating the CR at 904 may include one of (1) evaluating a CR for the selected set of resources for SL transmissions as a whole or (2) evaluating a CR for the selected set of resources for SL transmissions for each carrier (e.g., measuring a CR for (i) each SL resource pool in the set of SL resource pools or (ii) each carrier in the plurality of carriers in the selected set of resources for SL transmissions) and evaluating an average CR of the selected set of resources for SL transmissions based on the evaluated second CRs. For example, referring to FIGS. 6, 7, and 8, the UE 802 may evaluate 810 a CR for a set of SL resources (e.g., the set of CRs 610 or the CRs 727) as described in relation to FIGS. 6 and 7.

Finally, at 906 the UE may adjust, based on the CBR measured at 902 and the CR evaluated at 904 the at least one planned SL transmission in the set of resources for SL transmissions. For example, 906 may be performed by SL transmission adjustment component 1146. Adjusting the at least one planned SL transmission, in some aspects, may include identifying, based on the CBR measured at 902 for the selected resources for SL transmissions in each carrier of the plurality of carriers, a set of CR thresholds for the set of resources for SL transmissions in each carrier in the plurality of carriers. The set of CR thresholds, in some aspects, includes one or more CR thresholds for one or more SL transmission priorities as described above.

Adjusting, at 906, the at least one planned SL transmission, in some aspects, may identify, based on the measured CBR and a priority associated with the at least one planned SL transmission, that the evaluated CR is above a CR threshold (e.g., a CR threshold in the identified set of CR thresholds). The adjustment, at 906, may include at least one of (1) skipping the at least one planned SL transmission in the set of resources for SL transmissions or (2) reducing a set of resources associated with the at least one planned SL transmission to reduce the evaluated CR to a value below the CR threshold (e.g., reducing a number of frequency resources associated with the at least one planned SL transmission). For example, referring to FIG. 8, the UE 802 may adjust 812 at least one planned SL transmission.

In some aspects, the at least one planned SL transmission may be associated with the selected set of resources for SL transmissions in a first carrier in the plurality of carriers, and adjusting, at 906, the at least one planned SL transmission, may include identifying, based on a first SL transmission priority associated with the at least one planned SL transmission, that the evaluated CR for the selected set of resources for SL transmissions in the first carrier is above the CR threshold for the first SL transmission priority. The adjustment, at 906, may include selecting, based on (1) the measured CBR for the selected resources for SL transmissions in each carrier in the plurality of carriers, (2) a priority associated with the at least one planned SL transmission, and (3) the evaluated CR for the selected set of resources for SL transmissions in each carrier in the plurality of carriers, at least one resource in the selected set of resources for SL transmissions in a second carrier in the plurality of carriers (e.g., in a second resource pool in the set of SL resource pools or a second carrier in the plurality of carriers) to associate with the at least one planned SL transmission instead of the selected set of resources for SL transmissions in the first carrier. The evaluated CR for the selected set of resources for SL transmissions in the second carrier, in some aspects, may be below a CR threshold associated with the selected set of resources for SL transmissions in a second carrier.

Based on the measured CBR for the selected set of resources for SL transmissions in the first carrier being different from the measured CBR for the selected set of resources for SL transmissions in the second carrier, the CR threshold associated with the selected set of resources for SL transmissions in the second carrier is different from the CR threshold for the selected set of resources for SL transmissions in the first carrier. The set of resources for SL transmissions in the second carrier (e.g., a second resource pool in the set of SL resource pools or the second carrier in the plurality of carriers) may be a set of resources for SL transmissions in the second carrier associated with a lowest CBR or CR in the set of resources for SL transmissions (e.g., the set of SL resource pools or the carrier with a lowest CBR or CR in the plurality of carriers). In some aspects, the selection may be based on a function of the CBR and/or CR associated with each resource pool in the set of SL resource pools or with each carrier in the plurality of carriers and/or the priority of the at least one planned SL transmission. For example, referring to FIG. 8, the UE 802 may adjust 812 at least one planned SL transmission.

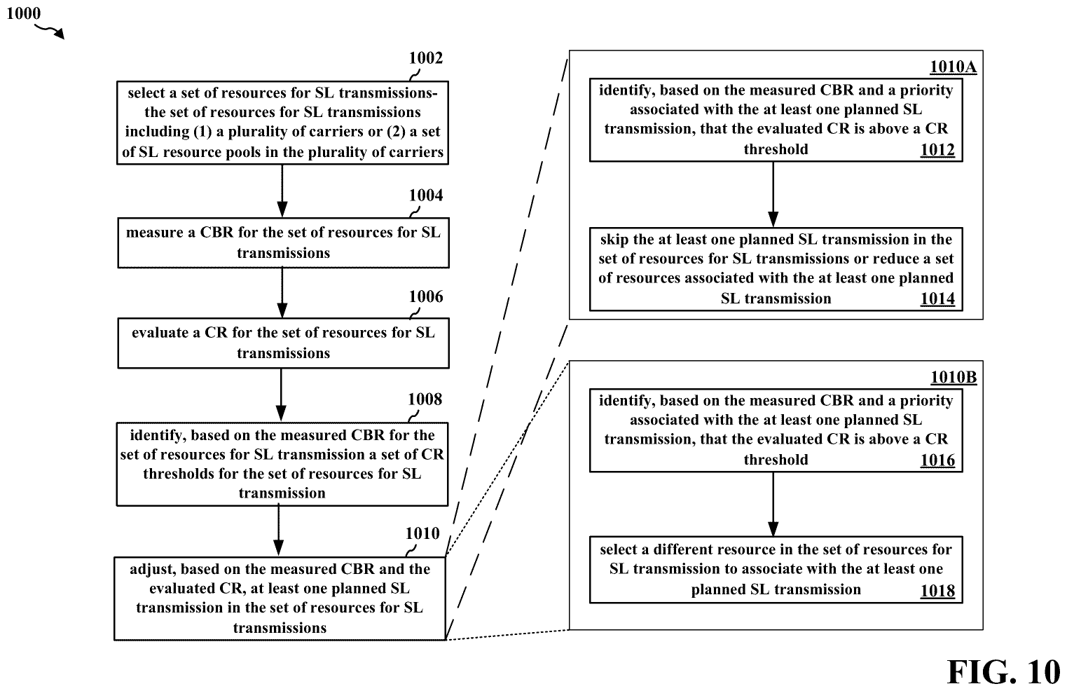

FIG. 10 is a flowchart 1000 of a method of wireless communication. The method may be performed by a UE (e.g., the UE 104, 402-408, and 802; the apparatus 1102). At 1002, the UE may select, based on one or more of a capacity of the UE, a capacity of a second UE with which the UE communicates, or a communication between the UE and the second UE. For example, 1002 may be performed by SL resource selection component 1140. The selection, in some aspects, corresponds to an autonomous (e.g., Mode 2) SL resource selection process. The set of resources for SL transmissions, in some aspects, may include (1) the plurality of carriers or (2) a set of SL resource pools in the plurality of carriers. For example, referring to FIG. 8, the UE 802 may select 805 a set of resources for SL transmissions.

At 1004, the UE may measure a CBR for the set of resources for SL transmissions. For example, 1004 may be performed by CBR measurement component 1142.

Measuring, at 1004, the CBR may include measuring a CBR for each SL resource pool in the set of SL resource pools or measuring a CBR for each carrier in the plurality of carriers. In some aspects, measuring, at 1004, the CBR may include one of (1) measuring a first CBR for the selected set of resources for SL transmissions as a whole or (2) measuring a second CBR for the selected set of resources for SL transmissions for each carrier (e.g., measuring a CBR for (i) each SL resource pool in the set of SL resource pools or (ii) each carrier in the plurality of carriers), and calculating an average CBR for the selected set of resources for SL transmissions (e.g., the set of SL resource pools or the plurality of carriers) based on the measured second CBRs. For example, referring to FIGS. 5, 7, and 8, the UE 802 may measure 808 a CBR for a set of SL resources (e.g., the set of CBRs 506, the CBR 526, or the CBRs 717) as described in relation to FIGS. 5 and 7.

At 1006, the UE may evaluate a CR for the set of resources for SL transmissions. The CR evaluated at 1006 may be associated with at least one planned SL transmission in the set of resources for SL transmissions. For example, 1006 may be performed by a CR evaluation component 1144. In some aspects, evaluating the CR at 1006 may include evaluating a CR for each SL resource pool in the set of SL resource pools or for each carrier in the plurality of carriers. Evaluating the CR at 1006 may include one of (1) evaluating a CR for the selected set of resources for SL transmissions as a whole or (2) evaluating a CR for the selected set of resources for SL transmissions for each carrier (e.g., measuring a CR for (i) each SL resource pool in the set of SL resource pools or (ii) each carrier in the plurality of carriers in the selected set of resources for SL transmissions) and evaluating an average CR of the selected set of resources for SL transmissions based on the evaluated second CRs. For example, referring to FIGS. 6, 7, and 8, the UE 802 may evaluate 810 a CR for a set of SL resources (e.g., the set of CRs 610 or the CRs 727) as described in relation to FIGS. 6 and 7.

At 1008, the UE may identify, based on the CBR measured at 1004 for the selected resources for SL transmissions in each carrier of the plurality of carriers, a set of CR thresholds for the set of resources for SL transmissions in each carrier in the plurality of carriers. The set of CR thresholds, in some aspects, includes one or more CR thresholds for one or more SL transmission priorities as described above. For example, 1008 may be performed by SL transmission adjustment component 1146. For example, referring to FIG. 8, the UE 802 may identify a set of CR limits as part of adjusting 812 the at least one planned SL transmission.

Finally, at 1010, the UE may adjust, based on the measured, at 1004, CBR and the evaluated, at 1006, CR, the at least one planned SL transmission in the set of resources for SL transmissions. For example, 1010 may be performed by SL transmission adjustment component 1146. Adjusting, at 1010, the at least one planned SL transmission, in some aspects, may be implemented as implementation 1010A or as implementation 1010B.

In the implementation 1010A, the UE may identify, at 1012, based on the measured CBR and a priority associated with the at least one planned SL transmission, that the evaluated CR is above a CR threshold (e.g., a CR threshold in the identified set of CR thresholds). In the implementation 1010A, the UE may also, at 1014, (1) skip the at least one planned SL transmission in the set of resources for SL transmissions or (2) reduce a set of resources associated with the at least one planned SL transmission to reduce the evaluated CR to a value below the CR threshold (e.g., reducing a number of frequency resources associated with the at least one planned SL transmission). For example, referring to FIG. 8, the UE 802 may adjust 812 at least one planned SL transmission.

In an implementation 1010B, the at least one planned SL transmission may be associated with the selected set of resources for SL transmissions in a first carrier in the plurality of carriers, the UE may identify, at 1016, based on a first SL transmission priority associated with the at least one planned SL transmission, that the evaluated CR for the selected set of resources for SL transmissions in the first carrier is above the CR threshold for the first SL transmission priority. In the implementation 1010B, the UE may select, at 1018, based on (1) the measured CBR for the selected resources for SL transmissions in each carrier in the plurality of carriers, (2) a priority associated with the at least one planned SL transmission, and (3) the evaluated CR for the selected set of resources for SL transmissions in each carrier in the plurality of carriers, at least one resource in the selected set of resources for SL transmissions in a second carrier in the plurality of carriers (e.g., in a second resource pool in the set of SL resource pools or a second carrier in the plurality of carriers) to associate with the at least one planned SL transmission instead of the selected set of resources for SL transmissions in the first carrier. The evaluated CR for the selected set of resources for SL transmissions in the second carrier, in some aspects, may be below a CR threshold associated with the selected set of resources for SL transmissions in a second carrier.

Based on the measured CBR for the selected set of resources for SL transmissions in the first carrier being different from the measured CBR for the selected set of resources for SL transmissions in the second carrier, the CR threshold associated with the selected set of resources for SL transmissions in the second carrier is different from the CR threshold for the selected set of resources for SL transmissions in the first carrier. The set of resources for SL transmissions in the second carrier (e.g., a second resource pool in the set of SL resource pools or the second carrier in the plurality of carriers) may be a set of resources for SL transmissions in the second carrier associated with a lowest CBR or CR in the set of resources for SL transmissions (e.g., the set of SL resource pools or the carrier with a lowest CBR or CR in the plurality of carriers). In some aspects, the selection may be based on a function of the CBR and/or CR associated with each resource pool in the set of SL resource pools or with each carrier in the plurality of carriers and/or the priority of the at least one planned SL transmission. For example, referring to FIG. 8, the UE 802 may adjust 812 at least one planned SL transmission.

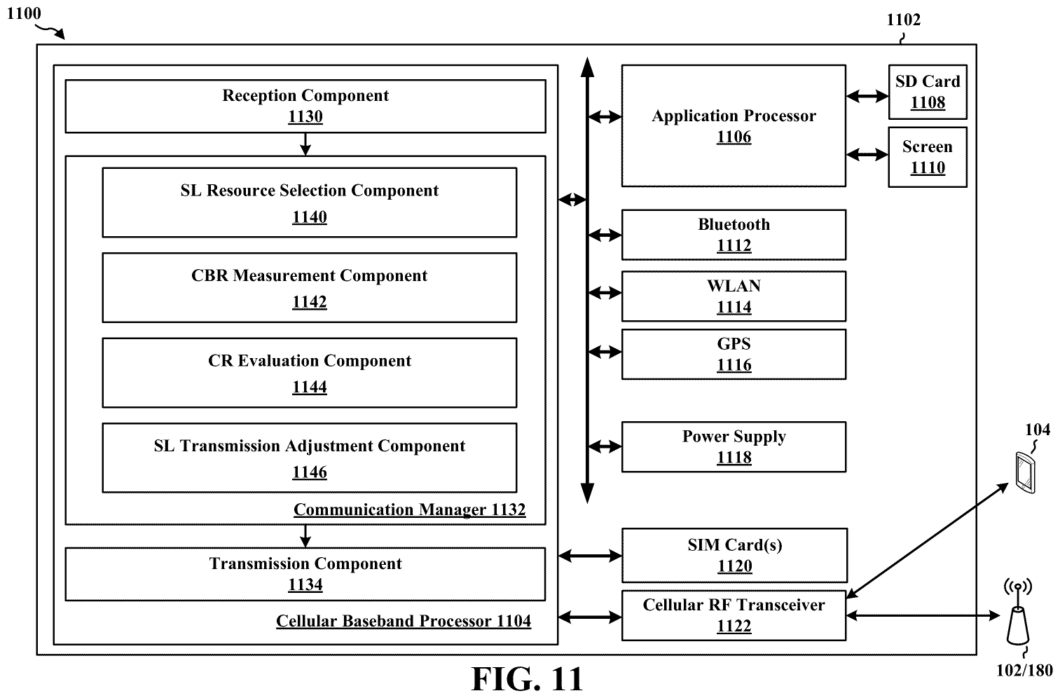

FIG. 11 is a diagram 1100 illustrating an example of a hardware implementation for an apparatus 1102. The apparatus 1102 may be a UE, a component of a UE, or may implement UE functionality. In some aspects, the apparatus 1102 may include a cellular baseband processor 1104 (also referred to as a modem) coupled to a cellular RF transceiver 1122. In some aspects, the apparatus 1102 may further include one or more subscriber identity modules (SIM) cards 1120, an application processor 1106 coupled to a secure digital (SD) card 1108 and a screen 1110, a Bluetooth module 1112, a wireless local area network (WLAN) module 1114, a Global Positioning System (GPS) module 1116, or a power supply 1118. The cellular baseband processor 1104 communicates through the cellular RF transceiver 1122 with the UE 104 and/or BS 102/180. The cellular baseband processor 1104 may include a computer-readable medium/memory. The computer-readable medium/memory may be non-transitory. The cellular baseband processor 1104 is responsible for general processing, including the execution of software stored on the computer-readable medium/memory. The software, when executed by the cellular baseband processor 1104, causes the cellular baseband processor 1104 to perform the various functions described supra. The computer-readable medium/memory may also be used for storing data that is manipulated by the cellular baseband processor 1104 when executing software. The cellular baseband processor 1104 further includes a reception component 1130, a communication manager 1132, and a transmission component 1134. The communication manager 1132 includes the one or more illustrated components. The components within the communication manager 1132 may be stored in the computer-readable medium/memory and/or configured as hardware within the cellular baseband processor 1104. The cellular baseband processor 1104 may be a component of the UE 350 and may include the memory 360 and/or at least one of the TX processor 368, the RX processor 356, and the controller/processor 359. In one configuration, the apparatus 1102 may be a modem chip and include just the cellular baseband processor 1104, and in another configuration, the apparatus 1102 may be the entire UE (e.g., see 350 of FIG. 3) and include the additional modules of the apparatus 1102.

The communication manager 1132 includes a SL resource selection component 1140 that is configured to select, based on one or more of a capacity of the UE, a capacity of a second UE with which the UE communicates, or a communication between the UE and the second UE, e.g., as described in connection with 1002 of FIG. 10. The communication manager 1132 further includes a CBR measurement component 1142 that receives input in the form of a selected set of resources for SL transmissions from the SL resource selection component 1140 and is configured to measure a CBR for the set of resources for SL transmissions, e.g., as described in connection with 902 and 1004 of FIGS. 9 and 10. The communication manager 1132 further includes a CR evaluation component 1144 that receives input in the form of the selected set of resources for SL transmissions from the SL resource selection component 1140 and is configured to evaluate a CR for the set of resources for SL transmissions, e.g., as described in connection with 904 and 1006 of FIGS. 9 and 10. The communication manager 1132 further includes a SL transmission adjustment component 1146 that is configured to identify, based on the measured CBR for the set of resources for SL transmissions in each carrier in the plurality of carriers, a set of CR thresholds for the set of resources for SL transmissions in each carrier in the plurality of carriers; identify based on the measured CBR and a priority associated with the at least one planned SL transmission, that the evaluated CR is above a CR threshold; (1) skip the at least one planned SL transmission in the set of resources for SL transmissions or (2) reduce a set of resources associated with the at least one planned SL transmission to reduce the evaluated CR to a value below the CR threshold; identify, based on a first SL transmission priority associated with the at least one planned SL transmission, that the evaluated CR for the selected set of resources for SL transmissions in the first carrier is above the CR threshold for the first SL transmission priority; and select, based on (1) the measured CBR for the selected resources for SL transmissions in each carrier in the plurality of carriers, (2) a priority associated with the at least one planned SL transmission, and (3) the evaluated CR for the selected set of resources for SL transmissions in each carrier in the plurality of carriers, at least one resource in the selected set of resources for SL transmissions in a second carrier in the plurality of carriers to associate with the at least one planned SL transmission instead of the selected set of resources for SL transmissions in the first carrier, e.g., as described in connection with 1008-1016.

The apparatus may include additional components that perform each of the blocks of the algorithm in the flowcharts of FIGS. 9 and 10. As such, each block in the flowcharts of FIGS. 9 and 10 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

As shown, the apparatus 1102 may include a variety of components configured for various functions. In one configuration, the apparatus 1102, and in particular the cellular baseband processor 1104, includes means for measuring a CBR for a set of resources for SL transmissions. The apparatus 1102, and in particular the cellular baseband processor 1104, may further include means for evaluating a CR for the set of resources for SL transmissions, the CR being associated with at least one planned SL transmission in the set of resources for SL transmissions. The apparatus 1102, and in particular the cellular baseband processor 1104, may further include means for adjusting, based on the measured CBR and the evaluated CR, the at least one planned SL transmission in the set of resources for SL transmissions. The apparatus 1102, and in particular the cellular baseband processor 1104, may further include means for selecting, based on a capacity of the first UE, the set of resources for SL transmissions, where the set of resources for SL transmissions includes at least one of (1) the plurality of carriers or (2) a set of SL resource pools in the plurality of carriers. The apparatus 1102, and in particular the cellular baseband processor 1104, may further include means for identifying, based on the measured CBR and a priority associated with the at least one planned SL transmission, that the evaluated CR is above a CR threshold. The apparatus 1102, and in particular the cellular baseband processor 1104, may further include means for at least one of: (1) skipping the at least one planned SL transmission in the set of resources for SL transmissions or (2) reducing a set of resources associated with the at least one planned SL transmission to reduce the evaluated CR to a value below the CR threshold. The apparatus 1102, and in particular the cellular baseband processor 1104, may further include means for identifying, based on the measured CBR for the set of resources for SL transmissions in each carrier in the plurality of carriers, a set of CR thresholds for the set of resources for SL transmissions in each carrier in the plurality of carriers, where the set of CR thresholds includes one or more CR thresholds for one or more SL transmission priorities. The apparatus 1102, and in particular the cellular baseband processor 1104, may further include means for identifying, based on a first SL transmission priority associated with the at least one planned SL transmission, that the evaluated CR for the selected set of resources for SL transmissions in the first carrier is above the CR threshold for the first SL transmission priority. The apparatus 1102, and in particular the cellular baseband processor 1104, may further include means for selecting, based on (1) the measured CBR for the selected resources for SL transmissions in each carrier in the plurality of carriers, (2) a priority associated with the at least one planned SL transmission, and (3) the evaluated CR for the selected set of resources for SL transmissions in each carrier in the plurality of carriers, at least one resource in the selected set of resources for SL transmissions in a second carrier in the plurality of carriers to associate with the at least one planned SL transmission instead of the selected set of resources for SL transmissions in the first carrier. The means may be one or more of the components of the apparatus 1102 configured to perform the functions recited by the means. As described supra, the apparatus 1102 may include the TX Processor 368, the RX Processor 356, and the controller/processor 359. As such, in one configuration, the means may be the TX Processor 368, the RX Processor 356, and the controller/processor 359 configured to perform the functions recited by the means.

In some aspects of wireless communication, UEs may apply congestion control to reduce the likelihood of causing a conflict and/or to ensure that the UE does not consume too many resources. In some aspects, “too many resources” may be specified by a configured or known (e.g., preconfigured) CR threshold associated. A congestion control mechanism for a single carrier may address issues of congestion for a UE utilizing a single carrier, but may not adequately address congestion issues associated with a UE utilizing multiple carriers for SL communication. For example, for a UE utilizing multiple carriers, a transmission associated with a first carrier may be associated with a CR that is above a CR threshold for that carrier, while the transmission could be sent on one of the other available carriers without causing a CR to be above a CR threshold or may be able to be transmitted if a CBR and CR are measured and evaluated, respectively, for the resources across the multiple carriers. The single-carrier congestion control may lead the UE to cancel the transmission, while the multi-carrier may enable the transmission in different ways as discussed below. Aspects presented herein provide for improved utilization of SL resources and channel access in a multi-carrier system.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

The following aspects are illustrative only and may be combined with other aspects or teachings described herein, without limitation.

Aspect 1 is an apparatus for wireless communication including at least one processor coupled to a memory and configured to measure a CBR for a set of resources for SL transmissions, the set of resources for SL transmissions including resources in a plurality of carriers; evaluate a CR for the set of resources for SL transmissions, the CR being associated with at least one planned SL transmission in the set of resources for SL transmissions; and adjust, based on the measured CBR and the evaluated CR, the at least one planned SL transmission in the set of resources for SL transmissions.

Aspect 2 is the apparatus of aspect 1, the at least one processor further configured to select, based on a capacity of the first UE, the set of resources for SL transmissions, where the set of resources for SL transmissions includes at least one of (1) the plurality of carriers or (2) a set of SL resource pools in the plurality of carriers.

Aspect 3 is the apparatus of aspect 2, where the set of resources for SL transmissions is selected based on a communication between the UE and a second UE.

Aspect 4 is the apparatus of any of aspects 2 and 3, where selecting the set of resources for SL transmissions corresponds to an autonomous SL resource selection process.

Aspect 5 is the apparatus of any of aspects 2 to 4, where the at least one processor is configured to measure the CBR for the set of resources for SL transmissions by one of (1) measuring a first CBR for the selected set of resources for SL transmissions as a whole or (2) measuring a second CBR for the selected set of resources for SL transmissions in each carrier in the plurality of carriers and calculating an average CBR of the selected set of resources for SL transmissions based on the measured second CBRs.

Aspect 6 is the apparatus of any of aspects 2 to 5, where the at least one processor is configured to evaluate the CR for the set of resources for SL transmissions by one of (1) evaluating a first CR for the selected set of resources for SL transmissions as a whole or (2) evaluating a second CR for the selected set of resources for SL transmissions in each carrier in the plurality of carriers and evaluating an average CR of the selected set of resources for SL transmissions based on the evaluated second CRs.

Aspect 7 is the apparatus of any of aspects 2 to 6, the at least one processor further configured to adjust the at least one planned SL transmission by identifying, based on the measured CBR and a priority associated with the at least one planned SL transmission, that the evaluated CR is above a CR threshold; and at least one of (1) skipping the at least one planned SL transmission in the set of resources for SL transmissions or (2) reducing a set of resources associated with the at least one planned SL transmission to reduce the evaluated CR to a value below the CR threshold

Aspect 8 is the apparatus of any of aspects 2 to 4, where the at least one processor is configured to measure the CBR for the set of resources for SL transmissions by measuring a CBR for the selected resources for SL transmissions in each carrier of the plurality of carriers, and where the at least one processor is configured to evaluate the CR for the set of resources for SL transmissions by evaluating a CR for the selected set of resources for SL transmissions in each carrier in the plurality of carriers.

Aspect 9 is the apparatus of aspect 8, the at least one processor further configured to identify, based on the measured CBR for the set of resources for SL transmissions in each carrier in the plurality of carriers, a set of CR thresholds for the set of resources for SL transmissions in each carrier in the plurality of carriers, where the set of CR thresholds includes one or more CR thresholds for one or more SL transmission priorities.

Aspect 10 is the apparatus of aspect 9, where the at least one planned SL transmission is associated with the selected set of resources for SL transmissions in a first carrier in the plurality of carriers, and where the at least one processor is configured to adjust the at least one planned SL transmission by identifying, based on a first SL transmission priority associated with the at least one planned SL transmission, that the evaluated CR for the selected set of resources for SL transmissions in the first carrier is above the CR threshold for the first SL transmission priority; and selecting, based on (1) the measured CBR for the selected resources for SL transmissions in each carrier in the plurality of carriers, (2) a priority associated with the at least one planned SL transmission, and (3) the evaluated CR for the selected set of resources for SL transmissions in each carrier in the plurality of carriers, at least one resource in the selected set of resources for SL transmissions in a second carrier in the plurality of carriers to associate with the at least one planned SL transmission instead of the selected set of resources for SL transmissions in the first carrier.

Aspect 11 is the apparatus of aspect 10, where the evaluated CR for the selected set of resources for SL transmissions in the second carrier is below a CR threshold associated with the selected set of resources for SL transmissions in a second carrier.

Aspect 12 is the apparatus of aspect 11, where, based on the measured CBR for the selected set of resources for SL transmissions in the first carrier being different from the measured CBR for the selected set of resources for SL transmissions in the second carrier, the CR threshold associated with the selected set of resources for SL transmissions in the second carrier is different from the CR threshold for the selected set of resources for SL transmissions in the first carrier.

Aspect 13 is the apparatus of any of aspects 1 to 12, further including a transceiver coupled to the at least one processor.

Aspect 14 is a method of wireless communication for implementing any of aspects 1 to 13.

Aspect 15 is an apparatus for wireless communication including means for implementing any of aspects 1 to 13.

Aspect 16 is a computer-readable medium storing computer executable code, where the code when executed by a processor causes the processor to implement any of aspects 1 to 13.

What is claimed is:

1. An apparatus for wireless communication at a user equipment (UE), comprising:
a memory; and
at least one processor coupled to the memory and configured to:
measure a channel busy ratio (CBR) for a set of resources for sidelink (SL) transmissions, the set of resources for SL transmissions comprising resources in a plurality of carriers;
evaluate a channel occupancy ratio (CR) for the set of resources for SL transmissions, the CR being associated with at least one planned SL transmission in the set of resources for SL transmissions; and
adjust, based on the measured CBR and the evaluated CR, the at least one planned SL transmission in the set of resources for SL transmissions.

2. The apparatus of claim 1, the at least one processor further configured to:
select, based on a capacity of the UE, the set of resources for SL transmissions, wherein the set of resources for SL transmissions comprises at least one of (1) the plurality of carriers or (2) a set of SL resource pools in the plurality of carriers.

3. The apparatus of claim 2, wherein the set of resources for SL transmissions is selected based on a communication between the UE and a second UE.

4. The apparatus of claim 2, wherein selecting the set of resources for SL transmissions corresponds to an autonomous SL resource selection process.

5. The apparatus of claim 2, wherein the at least one processor is configured to measure the CBR for the set of resources for SL transmissions by one of (1) measuring a first CBR for the selected set of resources for SL transmissions as a whole or (2) measuring a second CBR for the selected set of resources for SL transmissions in each carrier in the plurality of carriers and calculating an average CBR of the selected set of resources for SL transmissions based on the measured second CBRs.

6. The apparatus of claim 2, wherein the at least one processor is configured to evaluate the CR for the set of resources for SL transmissions by one of (1) evaluating a first CR for the selected set of resources for SL transmissions as a whole or (2) evaluating a second CR for the selected set of resources for SL transmissions in each carrier in the plurality of carriers and evaluating an average CR of the selected set of resources for SL transmissions based on the evaluated second CRs.

7. The apparatus of claim 2, wherein the at least one processor is configured to adjust the at least one planned SL transmission by:
identifying, based on the measured CBR and a priority associated with the at least one planned SL transmission, that the evaluated CR is above a CR threshold; and
at least one of: (1) skipping the at least one planned SL transmission in the set of resources for SL transmissions or (2) reducing a set of resources associated with the at least one planned SL transmission to reduce the evaluated CR to a value below the CR threshold.

8. The apparatus of claim 2, wherein the at least one processor is configured to measure the CBR for the set of resources for SL transmissions by measuring the CBR for the selected set of resources for SL transmissions in each carrier of the plurality of carriers, and wherein the at least one processor is configured to evaluate the CR for the set of resources for SL transmissions by evaluating the CR for the selected set of resources for SL transmissions in each carrier in the plurality of carriers.

9. The apparatus of claim 8, the at least one processor further configured to:
identify, based on the measured CBR for the set of resources for SL transmissions in each carrier in the plurality of carriers, a set of CR thresholds for the set of resources for SL transmissions in each carrier in the plurality of carriers, wherein the set of CR thresholds comprises one or more CR thresholds for one or more SL transmission priorities.

10. The apparatus of claim 9, wherein the at least one planned SL transmission is associated with the selected set of resources for SL transmissions in a first carrier in the plurality of carriers, and wherein the at least one processor is configured to adjust the at least one planned SL transmission by:
identifying, based on a first SL transmission priority associated with the at least one planned SL transmission, that the evaluated CR for the selected set of resources for SL transmissions in the first carrier is above the CR threshold for the first SL transmission priority; and
selecting, based on (1) the measured CBR for the selected resources for SL transmissions in each carrier in the plurality of carriers, (2) a priority associated with the at least one planned SL transmission, and (3) the evaluated CR for the selected set of resources for SL transmissions in each carrier in the plurality of carriers, at least one resource in the selected set of resources for SL transmissions in a second carrier in the plurality of carriers to associate with the at least one planned SL transmission instead of the selected set of resources for SL transmissions in the first carrier.

11. The apparatus of claim 10, wherein the evaluated CR for the selected set of resources for SL transmissions in the second carrier is below a CR threshold associated with the selected set of resources for SL transmissions in the second carrier.

12. The apparatus of claim 11, wherein, based on the measured CBR for the selected set of resources for SL transmissions in the first carrier being different from the measured CBR for the selected set of resources for SL transmissions in the second carrier, the CR threshold associated with the selected set of resources for SL transmissions in the second carrier is different from the CR threshold for the selected set of resources for SL transmissions in the first carrier.

13. The apparatus of claim 1, further comprising a transceiver coupled to the at least one processor.

14. A method of wireless communication at a user equipment (UE), comprising:
measuring a channel busy ratio (CBR) for a set of resources for sidelink (SL) transmissions, the set of resources for SL transmissions comprising resources in a plurality of carriers;
evaluating a channel occupancy ratio (CR) for the set of resources for SL transmissions, the CR being associated with at least one planned SL transmission in the set of resources for SL transmissions; and
adjusting, based on the measured CBR and the evaluated CR, the at least one planned SL transmission in the set of resources for SL transmissions.

15. The method of claim 14, further comprising:
selecting, based on a capacity of the UE, the set of resources for SL transmissions, wherein the set of resources for SL transmissions comprises at least one of (1) the plurality of carriers or (2) a set of SL resource pools in the plurality of carriers.

16. The method of claim 15, wherein the set of resources for SL transmissions is selected based on a communication between the UE and a second UE.

17. The method of claim 15, wherein selecting the set of resources for SL transmissions corresponds to an autonomous SL resource selection process.

18. The method of claim 15, wherein measuring the CBR for the set of resources for SL transmissions comprises one of (1) measuring a first CBR for the selected set of resources for SL transmissions as a whole or (2) measuring a second CBR for the selected set of resources for SL transmissions in each carrier in the plurality of carriers and calculating an average CBR of the selected set of resources for SL transmissions based on the measured CBRs.

19. The method of claim 15, wherein evaluating the CR for the set of resources for SL transmissions comprises one of (1) evaluating a first CR for the selected set of resources for SL transmissions or (2) evaluating a second CR for the selected set of resources for SL transmissions in each carrier in the plurality of carriers and evaluating an average CR of the selected set of resources for SL transmissions based on the evaluated second CRs.

20. The method of claim 15, wherein adjusting the at least one planned SL transmission comprises:
identifying, based on the measured CBR and a priority associated with the at least one planned SL transmission, that the evaluated CR is above a CR threshold; and
at least one of: (1) skipping the at least one planned SL transmission in the set of resources for SL transmissions or (2) reducing a set of resources associated with the at least one planned SL transmission to reduce the evaluated CR to a value below the CR threshold.

21. The method of claim 15, wherein measuring the CBR for the set of resources for SL transmissions comprises measuring the CBR for the selected set of resources for SL transmissions in each carrier of the plurality of carriers, and wherein evaluating the CR for the set of resources for SL transmissions comprises evaluating the CR for the selected set of resources for SL transmissions in each carrier of the plurality of carriers.

22. The method of claim 21, further comprising:
identifying, based on the measured CBR for the selected resources for SL transmissions in each carrier of the plurality of carriers, a set of CR thresholds for the set of resources for SL transmissions in each carrier in the plurality of carriers, wherein the set of CR thresholds comprises one or more CR thresholds for one or more SL transmission priorities.

23. The method of claim 22, wherein the at least one planned SL transmission is associated with the selected set of resources for SL transmissions in a first carrier in the plurality of carriers, and wherein adjusting the at least one planned SL transmission comprises:
identifying, based on a first SL transmission priority associated with the at least one planned SL transmission, that the evaluated CR for the selected set of resources for SL transmissions in the first carrier is above the CR threshold for the first SL transmission priority; and
selecting, based on (1) the measured CBR for the selected resources for SL transmissions in each carrier in the plurality of carriers, (2) a priority associated with the at least one planned SL transmission, and (3) the evaluated CR for the selected set of resources for SL transmissions in each carrier in the plurality of carriers, at least one resource in the selected set of resources for SL transmissions in a second carrier in the plurality of carriers to associate with the at least one planned SL transmission instead of the selected set of resources for SL transmissions in the first carrier.

24. The method of claim 23, wherein the evaluated CR for the selected set of resources for SL transmissions in the second carrier is below a CR threshold associated with the selected set of resources for SL transmissions in the second carrier.

25. The method of claim 24, wherein, based on the measured CBR for the selected set of resources for SL transmissions in the first carrier being different from the measured CBR for the selected set of resources for SL transmissions in the second carrier, the CR threshold associated with the selected set of resources for SL transmissions in the second carrier is different from the CR threshold for the selected set of resources for SL transmissions in the first carrier.

26. An apparatus for wireless communication at a user equipment (UE), comprising:
means for measuring a channel busy ratio (CBR) for a set of resources for sidelink (SL) transmissions, the set of resources for SL transmissions comprising resources in a plurality of carriers;
means for evaluating a channel occupancy ratio (CR) for the set of resources for SL transmissions, the CR being associated with at least one planned SL transmission in the set of resources for SL transmissions; and
means for adjusting, based on the measured CBR and the evaluated CR, the at least one planned SL transmission in the set of resources for SL transmissions.

27. The apparatus of claim 26, further comprising:
means for selecting, based on a capacity of the UE, the set of resources for SL transmissions, wherein the set of resources for SL transmissions comprises at least one of (1) the plurality of carriers or (2) a set of SL resource pools in the plurality of carriers.

28. The apparatus of claim 27, wherein the means for adjusting the at least one planned SL transmission comprises:
means for identifying, based on the measured CBR and a priority associated with the at least one planned SL transmission, that the evaluated CR is above a CR threshold; and
means for at least one of: (1) skipping the at least one planned SL transmission in the set of resources for SL transmissions or (2) reducing a set of resources associated with the at least one planned SL transmission to reduce the evaluated CR to a value below the CR threshold.

29. A computer-readable medium storing computer executable code at a user equipment (UE), the code when executed by a processor causes the processor to:
measure a channel busy ratio (CBR) for a set of resources for sidelink (SL) transmissions, the set of resources for SL transmissions comprising resources in a plurality of carriers;
evaluate a channel occupancy ratio (CR) for the set of resources for SL transmissions, the CR being associated with at least one planned SL transmission in the set of resources for SL transmissions; and
adjust, based on the measured CBR and the evaluated CR, the at least one planned SL transmission in the set of resources for SL transmissions.

30. The computer-readable medium of claim 29, wherein the code when executed by the processor causes the processor to adjust the at least one planned SL transmission by:
identifying, based on the measured CBR and a priority associated with the at least one planned SL transmission, that the evaluated CR is above a CR threshold; and
at least one of: (1) skipping the at least one planned SL transmission in the set of resources for SL transmissions or (2) reducing a set of resources associated with the at least one planned SL transmission to reduce the evaluated CR to a value below the CR threshold.
